(19) United States
(12) Patent Application Publication
(10) Pub. No.: US 2024/0003468 A1
(43) Pub. Date: Jan. 4, 2024

(54) TUBE FITTING

(71) Applicant: NIPPON PILLAR PACKING CO., LTD., Osaka-shi (JP)

(72) Inventors: Toshihide IIDA, Osaka-shi (JP); Kenji ONISHI, Osaka-shi (JP); Yu NOTOJI, Osaka-shi (JP); Shohei MINAMIHARA, Osaka-shi (JP); Hiroki TANABE, Osaka-shi (JP)

(73) Assignee: NIPPON PILLAR PACKING CO., LTD., Osaka-shi (JP)

(21) Appl. No.: 18/253,811

(22) PCT Filed: Aug. 26, 2021
(86) PCT No.: PCT/JP2021/031312

§ 371 Date: May 22, 2023

(30) Foreign Application Priority Data
Jan. 15, 2021 (JP) 2021-004677

(51) Int. Cl. F16L 15/04; F16L 15/06; F16L 19/025

(52) U.S. Cl. CPC F16L 15/04; F16L 15/06; F16L 19/025

(57) ABSTRACT

One of an external thread of a fitting body and an internal thread of a sleeve includes two thread ridges and the other includes two thread grooves. The two thread ridges have transverse cross sections different in shape or size. A transverse cross section of the first thread groove allows that of the first thread ridge to be fit thereinto. A transverse cross section of the second thread groove prevents that of the first thread ridge from being fit thereinto but allows that of the second thread ridge to be fit thereinto. A leading portion of the second thread ridge is tapered in width. A leading portion of the first thread groove is inversely tapered in width. A leading portion of the first thread ridge has a transverse cross section that extends beyond a transverse cross section of the leading portion of the second thread groove.

### TECHNICAL FIELD

The invention relates to tube fittings, in particular, ones equipped with multi-start threads.

### BACKGROUND ART

“Threads” are structures provided on cylindrical regions in surface layers of two mechanical elements for purpose of connection between the elements. Each thread has a ridge and a groove. A “thread ridge” is a convex portion spiraling at a constant pitch along an outer or inner periphery of a cylindrical region. A “thread groove” is a concave portion spiraling through space within the thread ridge. Typically, cross sections of thread ridge and groove perpendicular to their respective helices (which is hereinafter referred to as “transverse cross sections”) have a constant shape and size, except for transverse cross sections in both end portions of the helices. One of the elements to be connected with each other is provided with an “external thread” having a thread ridge on its outer periphery, and the other is provided with an “internal thread” having a thread ridge on its inner periphery. The external and inner threads are designed such that one of them has a thread ridge whose transverse cross sections are fit into those of a thread groove of the other, and in addition, the one's thread ridge spirals at the same pitch as the other's thread groove. Accordingly, when the external and inner threads relatively rotate around a common axis with their respective tips coaxially in contact with each other, the one's thread ridge enters the other's thread groove. As a result, the external thread cannot escape from the inside of the internal thread only by being axially pulled, and thus, the two elements are kept connected with each other.

“Multi-start threads” are threads each including two or more thread ridges. Compared with single start threads including only one thread ridge, multi-start threads have a longer lead, i.e., a distance that they axially travel per rotation. Accordingly, in contrast to single start threads, multi-start threads are easier to reduce rotation numbers required for connection between external and internal threads, thus used for purpose of reduction in time required for the connection. (See e.g., JP 2020-105898 A.)

Using multi-start threads in tube fittings expedites process of connecting tubes through the tube fittings. Accordingly, tube fittings equipped with multi-start threads are useful in piping equipment used for manufacture of, for example, semiconductors, medical supplies, medicines, or foods, for the following reason. Since the piping equipment needs frequent maintenance, such as washing, reduction in time required for connection/disconnection of pipes is effective at easing burdens on workers performing the maintenance. Tube fittings with multi-start threads are also useful in piping equipment installed in vehicles to carry gasoline, coolant water, exhaust gas or the like. Ensuring safety of vehicles requires an especially high reliability of the piping equipment. To satisfy the requirement while keeping a high ease of assembly of the piping equipment, it is effective that multi-start threads are used in tube fittings to enable quick and reliable connection of tubes.

### CITATION LIST

Patent Literature 1: JP 2020-105898 A
Patent Literature 2: JP 2002-350704 A
Patent Literature 3: JP 2002-506411 A

### SUMMARY OF INVENTION

In typical multi-start threads, all thread ridges have transverse cross sections of the same shape and size, and thus, one of external and internal threads allows each thread ridge of the one to enter any thread groove of the other. Accordingly, rotation angles of the one relative to the other when the one's thread ridges start to enter the other's thread grooves are equal in number to the one's thread ridges. (The rotation angles are hereinafter referred to as “engagement start positions.”) External and internal threads in a different engagement start position cause their thread ridges to finish entering their thread grooves when reaching a different rotation angle therebetween (which are hereinafter referred to as “engagement finish position”), and thus, engagement finish positions are equal in number to thread ridges of each of the external and internal threads.

For some applications of multi-start threads, it may be undesirable that their engagement finish positions are equal in number to their thread ridges. For example, for an application disclosed in JP 2020-105898 A, two steel pipes must be joined at a predetermined rotation angle relative to each other. For an application disclosed in JP 2002-506411 A, a proper rotation angle of a container and a stop relative to each other is limited due to their respective rotationally asymmetric shapes. Accordingly, those applications require a technology of eliminating, from engagement finish positions of multi-start threads, those in which rotation angles between the two steel pipes or between the container and stop are improper. As such a technology, certain multi-start threads are known (cf. JP 2020-105898 A, JP 2002-350704 A, and JP 2002-506411A), which are designed such that a specific thread ridge differs from others in shape or size of transverse cross sections. Differences in shape or size of transverse cross sections are selected such that the specific thread ridge cannot enter thread grooves that other thread ridges should enter. Thus, the number of engagement start positions is limited to be smaller than that of thread ridges, such as “one,” and therefore, the number of engagement finish positions is also limited.

However, design of multi-start threads whose different thread ridges have transverse cross sections different in shape or size can cause the following problems.

Not only typical multi-start threads but also typical single start threads have thread ridges whose leading portions in the direction of their respective helices are shaped to be tapered in width (i.e., circumferential length of a portion of each transverse cross section, the portion intersecting with a cylindrical surface coaxial with each thread). In other words, the leading portions of thread ridges smoothly reduce in width toward leading ends of their respective helices. Thus, thread ridges of one of external and internal threads has the leading portions sufficiently narrower in width than thread grooves of the other, and accordingly, the thread ridges can easily enter the thread grooves when the external and internal threads relatively rotate with their tips in contact with each other. In addition, contact of the leading portions of the thread ridges with the thread grooves causes main bodies of the thread ridges following the leading portions to smoothly enter the thread grooves. This enables the external and internal threads to easily start to be engaged with each other.

Preferably, other multi-start threads whose different thread ridges have transverse cross sections designed to differ in shape or size also have leading portions of the thread ridges tapered in width to make external and internal threads easily start to be engaged with each other. However, the tapered leading portions are sufficiently narrower in width than main bodies following them, thus able to enter thread grooves that the main bodies cannot enter (which are hereinafter referred to as“improper thread grooves”). As a leading portion enter an improper thread groove more deeply, its transverse cross sections smoothly enlarge within the improper thread groove, and thus, deformation of the leading portion caused by contact with the improper thread groove smoothly increases. In addition, change in transverse cross section between the leading portion and the following main body is continuous, and accordingly, deformation of the leading portion is likely to facilitate deformation of the main body. In this case, resistive force that the leading portion receives from walls of the improper thread groove smoothly increase, and thus, regardless of the increase of the resistive force, a worker tends to forcibly rotate the external and internal threads. As a result, the main body may be forced to enter the improper thread groove to potentially cause friction welding, plastic deformation, or damage.

An object of the invention is to solve the above-mentioned problems, in particular, to provide a tube fitting equipped with multi-start threads whose engagement finish positions are smaller in number than their thread ridges and that make external and internal threads easily start to be engaged with each other.

According to one aspect of the invention, a tube fitting includes a fitting body and a sleeve. The fitting body has a tubular shape whose first axial end portion includes an external thread and whose second axial end portion is to be connected with a first tube. The sleeve has a first axial end portion that is to be connected with a second tube and a second axial end portion that includes an internal thread to be engaged with the external thread. One of the external and internal threads includes first and second thread ridges and the other includes first and second thread grooves. The first and second thread ridges have transverse cross sections different in shape or size. The transverse cross section of the first thread groove allows the transverse cross section of the first thread ridge to be fit thereinto. The transverse cross section of the second thread groove prevents the transverse cross section of the first thread ridge from being fit thereinto but allows the transverse cross section of the second thread ridge to be fit thereinto. The first and second thread ridges and the first and second thread grooves have leading portions in their respective directions in which they spiral. The leading portion of the second thread ridge is tapered in width. The leading portion of the first thread groove is inversely tapered in width, i.e., has a width smoothly increasing towards its leading end. The leading portion of the first thread ridge has a transverse cross section that extends beyond a transverse cross section of the leading portion of the second thread groove.

A leading end of the first thread ridge may include a projecting portion that protrudes along an elongated direction of a helix along which the first thread ridge spirals. The projecting portion has a transverse cross section that is fit into the transverse cross section of the second thread groove.

A circumferential section of an outer periphery of the fitting body may include a first engaging portion, and a circumferential section of an outer periphery of the sleeve may include a second engaging portion. In this case, the first engaging portion is snap-fitted with the second engaging portion when the internal thread reaches an engagement finish position relative the external thread.

In the above-mentioned tube fitting according to the invention, one of the external thread of the fitting body and the internal thread of the sleeve includes the first and second thread ridges and the other includes the first and second thread grooves. In other words, the fitting body and the sleeve are coupled through multi-start threads. This reduces the number of relative rotations of the fitting body and the sleeve required for coupling of them.

The first and second thread ridges have transverse cross sections different in shape or size. In particular, the transverse cross section of the first thread ridge is fit into that of the first thread groove, but not into that of the second thread groove. The transverse cross section of the second thread ridge is fit into that of the second thread groove. Accordingly, the external thread of the fitting body can be engaged with the internal thread of the sleeve only when the first thread ridge enters the first thread groove, and the second thread ridge enters the second thread groove. This reduces engagement start positions to be smaller in number than the thread ridges. Thus, engagement finish positions are also reduced similarly.

The leading portion of the first thread groove is inversely tapered and the leading portion of the second thread ridge is tapered, and thus, the first thread ridge can easily enter the leading portion of the first thread groove and the leading portion of the second thread ridge can easily enter the second thread groove while the external thread of the fitting body and the internal thread of the sleeve relatively rotate with their tips in contact with each other. In addition, the leading portion of the first thread groove changes its width smoothly, thus smoothly guiding the first thread ridge contacting it into the main body following it. Similarly, the leading portion of the second thread ridge changes its width smoothly, and thus, when contacting the second groove, causes the following main body to be smoothly guided into the second thread groove. In these manners, the external and internal threads can easily start to be engaged with each other.

The transverse cross section of the leading portion of the first thread ridge extends beyond that of the second thread groove, and accordingly, when the external thread of the fitting body and the internal thread of the sleeve relatively rotate with their tips in contact with each other, the leading end of the first thread ridge hits the leading end of the second thread groove, thus being unable to enter the second thread groove. Therefore, the second thread ridge also cannot enter the first thread groove. This prevents the external and internal threads from troubles such as friction welding.

When the leading portion of the first thread ridge is provided with the projecting portion, the external thread of the fitting body and the internal thread of the sleeve, which are arranged such that the leading end of the first thread ridge is opposed to the leading end of the second thread groove, allows the projecting portion to enter the second thread groove. Subsequently, the leading end of the first thread ridge hits the leading end of the second thread groove. The projecting portion entering and hitting the second thread groove is sensed by a worker as haptic responses, and thus, the tube fitting can remind the worker the arrangement of the external and internal threads. Since the arrangement can be a clue, the worker can easily find the engagement start position.

The fitting body includes the first engaging portion, and the sleeve may include the second engaging portion. In this case, the first engaging portion is snap-fitted with the second engaging portion when the internal thread of the sleeve reaches an engagement finish position relative to the external thread of the fitting body. By visually identifying appearance of the snap-fit of the first and second engaging portions and aurally identifying sound created by the snap-fit, a worker can easily confirm if the external and internal threads reach the engagement finish position. Since engagement finish positions are smaller in number than thread ridges of each of the external and internal threads, the number of the first or second engaging portions can be cut down to reduce in size or manufacturing cost of the fitting body.

### BRIEF DESCRIPTION OF DRAWINGS

FIG. 1 is a perspective view showing an appearance of a tube fitting according to an embodiment of the invention;

FIG. 2 is a perspective exploded view of the tube fitting in FIG. 1;

FIG. 3 is a cross-section view along a line III-III in FIG. 1;

FIG. 4A is an enlarged view of a region surrounded by a broken line IVa in FIG. 3;

FIG. 4B is an enlarged view of a region surrounded by a broken line IVb in FIG. 3;

FIG. 4C is a diagram showing comparison between a transverse cross section of the first thread ridge of the external thread and a transverse cross section of the first thread groove of the internal thread;

FIG. 4D is a diagram showing comparison between a transverse cross section of the second thread ridge of the external thread and a transverse cross section of the second thread groove of the internal thread;

FIG. 4E is a diagram showing comparison between a transverse cross section of the first thread ridge of the external thread and a transverse cross section of the second thread groove of the internal thread;

FIGS. 5A and 5B are enlarged side views schematically showing parts of tips of the external and internal threads in contact with each other, FIG. 5A showing those when a relative rotation angle between the external and internal threads is close to an engagement start position, FIG. 5B showing those when the relative rotation angle is far off the engagement start position; and

FIG. 6A is a perspective view showing an appearance of a modification of the tube fitting according to the embodiment of the invention, and FIG. 6B is an enlarged view of a region surrounded by a broken line in FIG. 6A.

### DESCRIPTION OF EMBODIMENTS

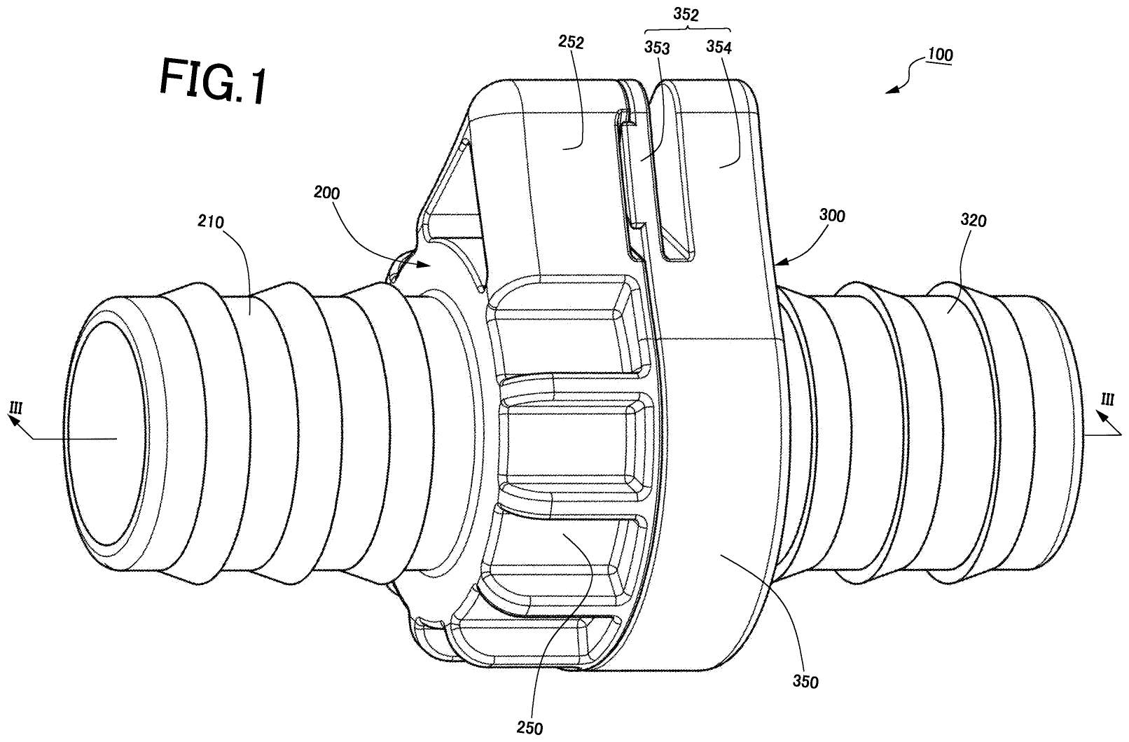

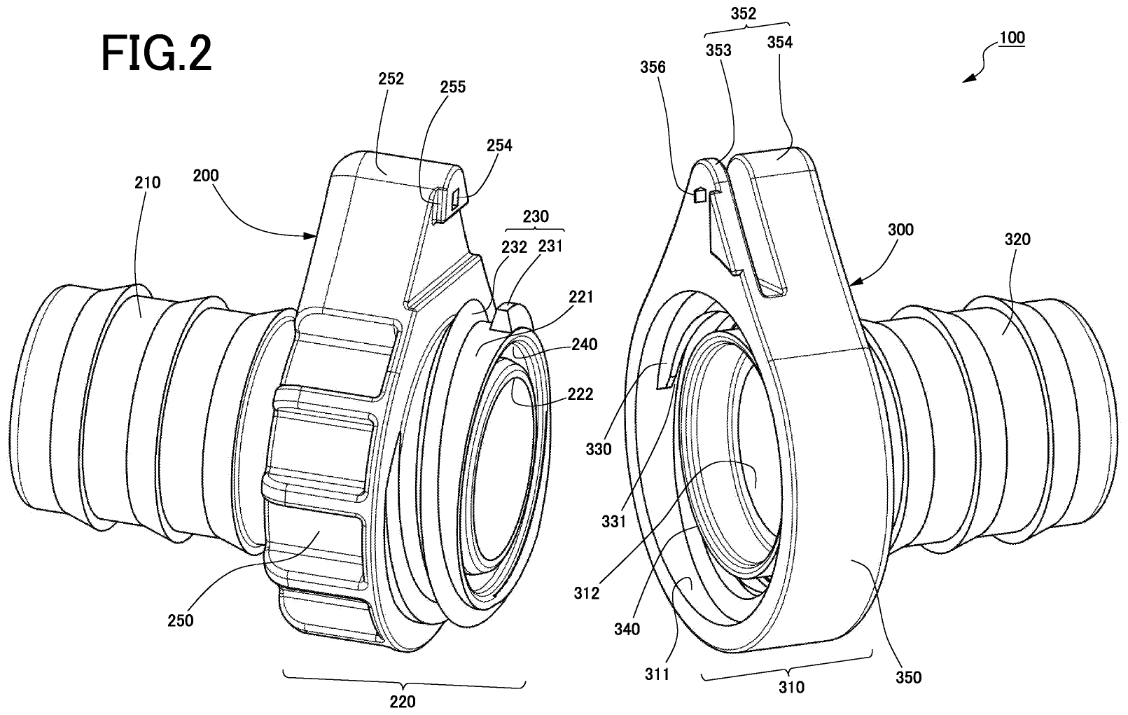

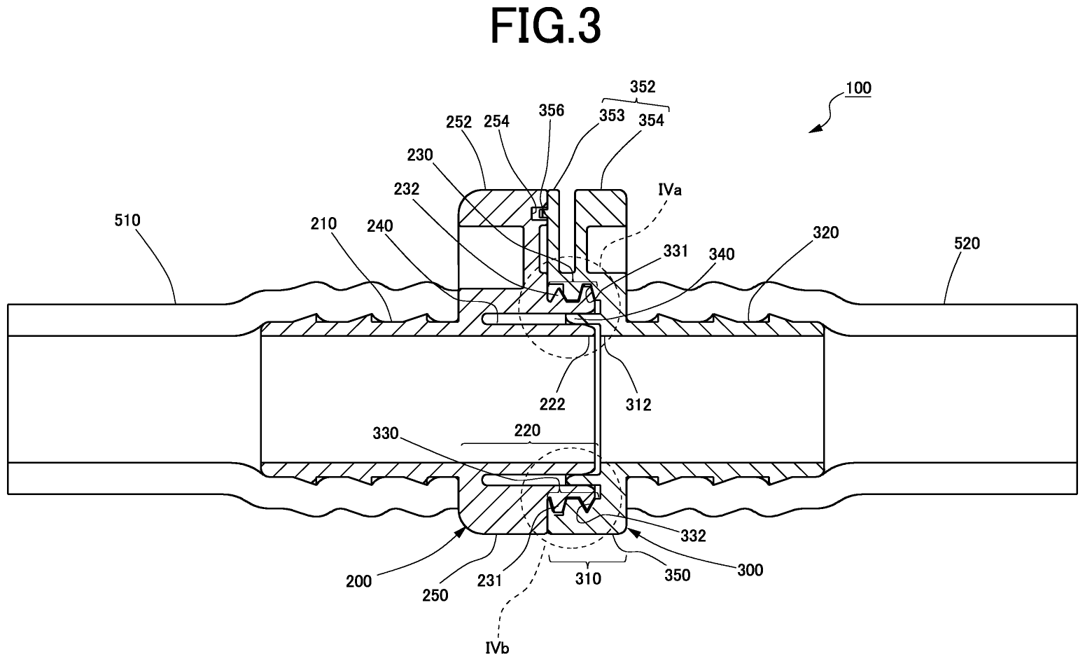

FIG. 1 is a perspective view showing an appearance of a tube fitting 100 according to an embodiment of the invention. FIG. 2 is a perspective exploded view of the tube fitting 100. FIG. 3 is a cross-section view along a line III-III in FIG. 1. The tube fitting 100 is used for, for example, connecting a first hose 510 with a second hose 520 in a vehicle (cf. FIG. 3). The first hose 510 and the second hose 520 are made of resin such as high-density polyethylene (HDPE) and included in cooling lines for a battery pack of an electric vehicle (EV). The tube fitting 100 includes a fitting body 200 connected with the first hose 510 and a sleeve 300 connected with the second hose 520. Both the fitting body 200 and the sleeve 300 are circular-cylindrical members made of resin such as polyamide (PA) or glass-reinforced polyamide (PA-GF). Through inner cavities of the fitting body 200 and the sleeve 300, the inside of the first hose 510 communicates with the inside of the second hose 520. In other words, the inner cavities of the fitting body 200 and the sleeve 300 serve as a channel connecting the two hoses 510 and 520 and allowing coolant water (LLC) to flow therethrough.

One axial end portion 210 (which is hereinafter referred to as “first axial end portion”) of the fitting body 200 is coaxially placed within the first hose 510. The other axial end portion 220 (which is hereinafter referred to as “second axial end portion”) of the fitting body 200 includes an external thread 230, an annular groove 240, and a flange 250. The external thread 230 is, for example, a double start thread and includes a first thread ridge 231 and a second thread ridge 232, which spiral along the outer periphery 221 of the second axial end portion 220 (cf. FIG. 2). Positions of the first thread ridge 231 and the second thread ridge 232 in the circumferential direction of the second axial end portion 220 are 180 degrees different from each other. The annular groove 240 is located between the external thread 230 and an opening 222 of the second axial end portion 220 in the radial direction of the second axial end portion 220 and coaxially surrounds the opening 222. The flange 250 is a circular-ring portion extending radially outward from an outer periphery 221 of the second axial end portion 220 and adjacent to a base end of the external thread 230 (the left end thereof in FIGS. 2 and 3). From a circumferential section of the outer periphery of the flange 250 (the top section thereof in FIGS. 1-3), a first engaging portion 252 protrudes radially outward, whose tip portion in the direction in which the first engaging portion 252 protrudes (the top end portion thereof in FIGS. 2 and 3) includes an engaging hole 254 extending in the axial direction of the fitting body 200.

One axial end portion 310 (which is hereinafter referred to as “first axial end portion”) of the sleeve 300 includes an internal thread 330, an annular protrusion 340, and a flange 350. The other axial end portion 320 (which is hereinafter referred to as “second axial end portion”) of the sleeve 300 is coaxially placed within the second hose 520 (cf. FIG. 3.)

The internal thread 330 is a multi-start thread whose thread ridges are equal in number to those of the external thread 230 of the fitting body 200, e.g., a double start thread. A first thread groove 331 and a second thread groove 332 of the internal thread 330 spiral along an inner periphery 311 of the first axial end portion 310 (cf. FIG. 2). Positions of the thread grooves 331 and 332 in the circumferential direction of the first axial end portion 310 are 180 degrees different from each other. When the external thread 230 brings its tip (the right end in FIGS. 2 and 3) coaxially in contact with the tip of the internal thread 330 (the left end thereof in FIGS. 2 and 3) and then rotates around a common axis shared with the internal thread 330, the first thread ridge 231 and the second thread ridge 232 enters the first thread groove 331 and the second thread groove 332, respectively. (Details will be described later.) Engagement of the external thread 230 with the internal thread 330 in this manner establishes coaxial connection of the fitting body 200 with the sleeve 300 as shown in FIGS. 1 and 3.

Since being multi-start threads, the external thread 230 and the internal thread 330 can relatively rotate fewer times to couple the fitting body 200 with the sleeve 300 than single start threads. Preferably, the rotation angle that the external thread 230 requires to completely engage with the internal thread 330, i.e., the rotation angle from an engagement start position to a corresponding engagement finish position, is designed to be an angle, such as 90 degrees or less, at which a worker can easily twist, with one hand, either the first hose 510 or the second hose 520 around its longitudinal axis. This enables the worker to couple the fitting body 200, which has been already connected with the first hose 510, to the sleeve 300, which has been already connected with the second hose 520.

The annular protrusion 340 is located, in the radial direction of the first axial end portion 310, between the internal thread 330 and an opening 312 of the first axial end portion 310 and coaxially surrounds the opening 312. As shown in FIG. 3, when the fitting body 200 is connected with the sleeve 300, the annular protrusion 340 fits in the annular groove 240 of the fitting body 200. Either the inner diameter of the annular protrusion 340 is smaller than the diameter of a radially inward surface of the annular groove 240, or the outer diameter of the annular protrusion 340 is larger than the diameter of a radially outward surface of the annular groove 240, and accordingly, the annular protrusion 340 is press-fitted into the annular groove 240. In this case, either the inner periphery of the annular protrusion 340 and the radially inward surface of the annular groove 240, or the outer periphery of the annular protrusion 340 and the radially outward surface of the annular groove 240, firmly press each other to seal gaps therebetween.

The flange 350 is a circular-ring portion extending radially outward from the internal thread 330. From a circumferential section of the outer periphery of the flange 350 (the top section thereof in FIGS. 1-3), a second engaging portion 352 protrudes radially outward. The second engaging portion 352 is designed such that, as shown in FIGS. 1 and 3, when the fitting body 200 is completely connected with the sleeve 300, i.e., when the external thread 230 and the internal thread 330 reach an engagement finish position, the second engaging portion 352 is located at the same position as the first engaging portion 252 in a common circumferential direction shared by the fitting body 200 and the sleeve 300. This enables a worker to confirm by eye if the external thread 230 and the internal thread 330 reach an engagement finish position by seeing the first engaging portion 252 and the second engaging portion 352 located at the same circumferential position.

The second engaging portion 352 includes a thin-plate part 353 and a thick-plate part 354. In the axial direction of the sleeve 300, the thin-plate part 353 is near the tip of the internal thread 330 (the left end thereof in FIGS. 2 and 3), the thick-plate part 354 is near the base end of the internal thread 330 (the right end thereof in FIGS. 2 and 3). The thin-plate part 353 is smaller in axial thickness than the thick-plate part 354. In the axial direction of the sleeve 300, the thin-plate part 353 and the thick-plate part 354 face each other across a gap. The tip of the thin-plate part 353 in the direction in which the thin-plate part 353 protrudes (the top end thereof in FIGS. 2 and 3) includes an engaging projection 356 protruding in the axial direction of the sleeve 300. When the external thread 230 is engaged with the internal thread 330, the engaging projection 356 is snap-fitted into the engaging hole 254 of the first engaging portion 252 as follows. Immediately before the threads 230 and 330 reach an engagement finish position, the engaging projection 356 hits a side 255 of the first engaging portion 252. This forces the thin-plate part 353 to bow towards the thick-plate part 354, and thus, the engaging projection 356 moves over the side 255 of the first engaging portion 252. When the threads 230 and 330 reach the engagement finish position, the engaging projection 356 enters the engaging hole 254 and the bowing thin-plate part 353 snaps back to the original straight shape. Then, sound of the thin-plate part 353 slapping a surface of the first engaging portion 252 reverberates through the gap between the thin-plate part 353 and the thick-plate part 354. By hearing the reverberating sound, a worker can confirm by ear if the external thread 230 and the internal thread 330 reach the engagement finish position.

[Details of Cross Sections of Thread Ridge and Groove]

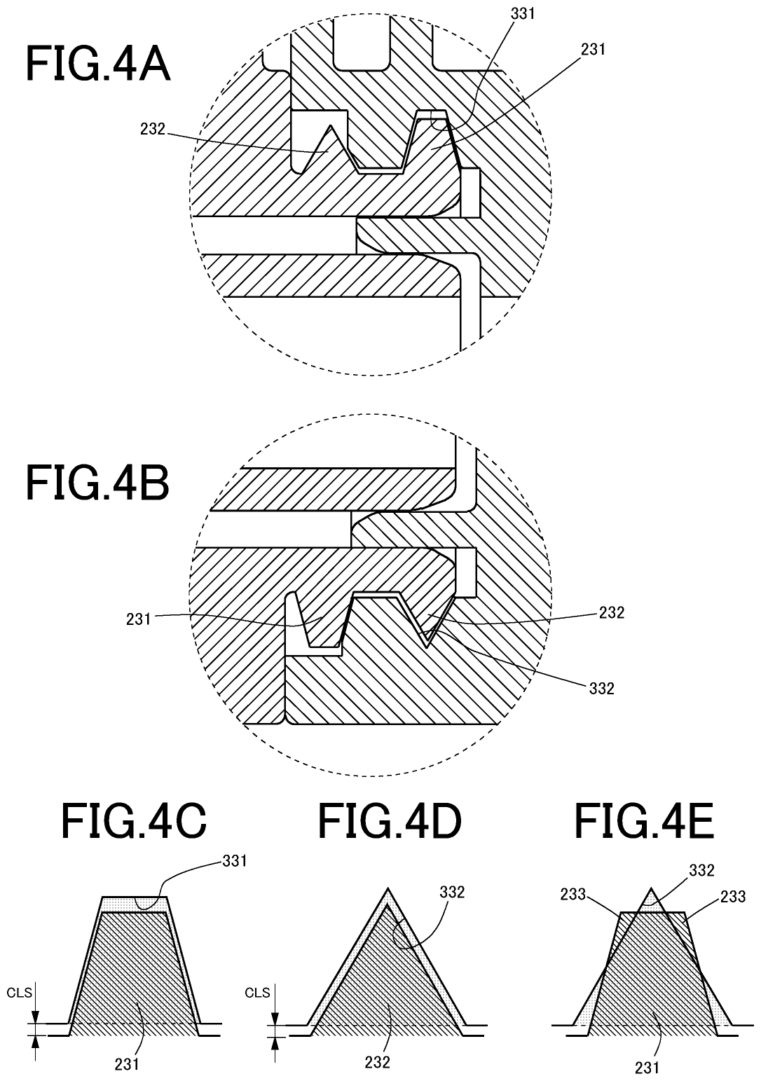

FIGS. 4A and 4B are enlarged views of regions surrounded by broken lines IVa and IVb in FIG. 3, respectively. When the external thread 230 is engaged with the internal thread 330, as shown in FIG. 4A, the first thread ridge 231 is placed within the first thread groove 331, and as shown in FIG. 4B, the second thread ridge 232 is placed within the second thread groove 332. These mean as follows:

FIG. 4C is a diagram showing comparison between a transverse cross section of the first thread ridge 231 and a transverse cross section of the first thread groove 331. FIG. 4D is a diagram showing comparison between a transverse cross section of the second thread ridge 232 and a transverse cross section of the second thread groove 332. As shown in FIGS. 4C and 4D, the transverse cross section of the first thread ridge 231 fits into the transverse cross section of the first thread groove 331, and the transverse cross section of the second thread ridge 232 fits into the transverse cross section of the second thread groove 332. (When more appropriate, a radial gap CLS is provided between the fitting body 200 and the sleeve 300, and thus, a portion of the transverse cross section of the first thread ridge 231 spreads radially inward from the transverse cross section of the first thread groove 331, and a portion of the transverse cross section of the second thread ridge 232 spreads radially inward from the transverse cross section of the second thread groove 332. However, these portions do not prevent the thread ridges from entering the thread grooves, thus being neglectable.)

In addition, it is understandable from FIGS. 4A and 4B that the first thread ridge 231 and the second thread ridge 232 differ from each other in shape of transverse cross sections. (Note that cross sections of the thread ridges 231 and 232 in FIGS. 4A and 4B do not exactly show transverse ones thereof.) More specifically, transverse cross sections of the first thread ridge 231 are of a trapezoidal shape, and those of the second thread ridge 232 are of a triangular shape. These transverse cross sections of difference shapes are designed to meet the following condition.

FIG. 4E is a diagram showing comparison between a transverse cross section of the first thread ridge 231 and a transverse cross section of the second thread groove 332. As shown in FIG. 4E, a head 233 of the first thread ridge 231 (i.e., a portion at the largest distance from the center axis of the external thread 230, which FIG. 4E shows as the top end) stretches beyond the second thread groove 332 in the width direction (left-right direction in FIG. 4E). That is, the transverse cross section of the first thread ridge 231 extends beyond that of the second thread groove 332.

Since this condition is satisfied, the first thread ridge 231 cannot enter the second thread groove 332. Accordingly, the external thread 230 is engaged with the internal thread 330 only when the first thread ridge 231 enters the first thread groove 331 and the second thread ridge 232 enters the second thread groove 332. In other words, the number of engagement start positions is suppressed to “one” less than the number of thread ridges, “two.” Similarly, the number of engagement finish positions is suppressed to “one.” As a result, the number of each of the first engaging portion 252 and the second engaging portion 352 only has to be set to “one.” This is advantageous to reduction in size and manufacturing cost of the tube fitting 100.

[Details of Tips of External and Internal Threads]

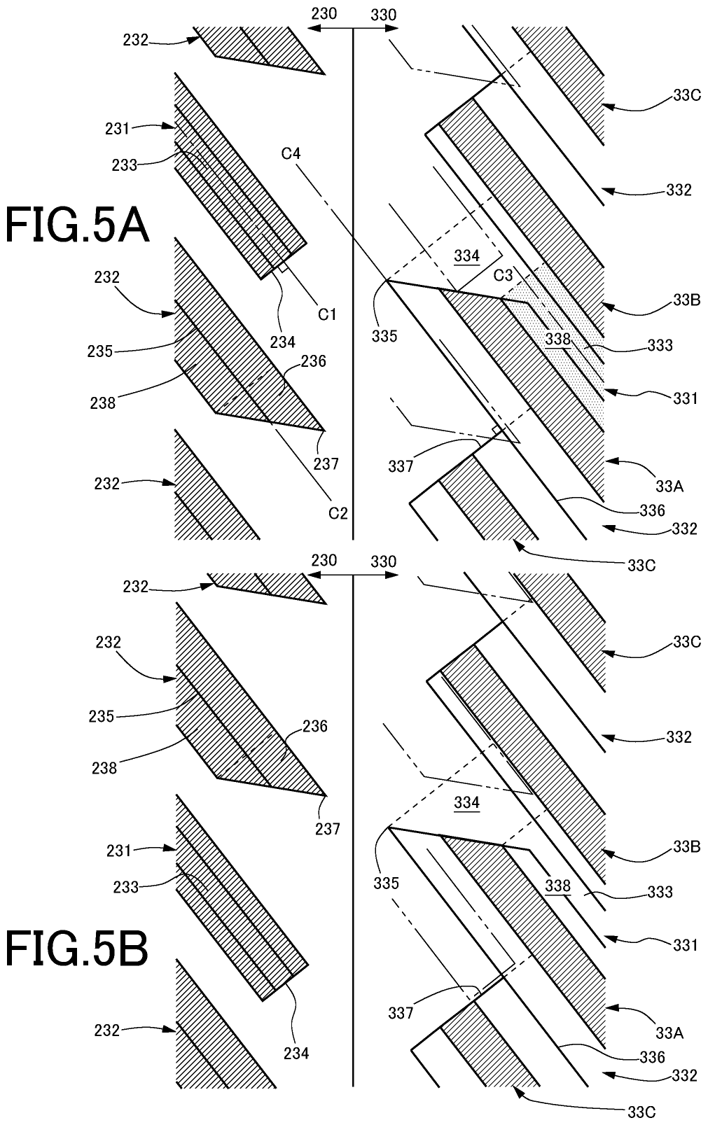

FIGS. 5A and 5B are enlarged side views schematically showing parts of tips of the external and internal threads in contact with each other. The left sides of FIGS. 5A and 5B show the external thread 230, and the right sides thereof show the internal thread 330. FIGS. 5A and 5B show different relative rotation angles between the external thread 230 and the internal thread 330. Hatched regions in the external thread 230 represent the first thread ridge 231 and the second thread ridge 232. In the internal thread 330, the first thread groove 331, the second thread groove 332, and thread ridges 33A, 33B, and 33C between the grooves 331 and 332 are drawn as if they can be seen through a peripheral wall of the internal thread 330. Hatched regions in the internal thread 330 represent heads of the thread ridges 33A, 33B, and 33C (i.e., portions at the minimum distance from the center axis of the internal thread 330).

For convenience of explanation, both the external thread 230 and the internal thread 330 in FIGS. 5A and 5B are supposed to include three or more thread ridges in contrast to the threads in FIGS. 2-4. In addition, only one of the thread ridges of the external thread 230 is the first thread ridge 231, and others are the second thread ridge 232. In this case, only one of the thread grooves of the internal thread 330 is the first thread groove 331, and others are the second thread groove 332. Accordingly, the number of engagement start positions of the threads 230 and 330 is limited to only one.

The first thread ridge 231 has transverse cross sections of constant shape and size thoroughly to its leading end 234 in the direction in which the first thread ridge 231 spirals, for example, the direction in which the center line C1 of its head 233 extends. In particular, the surface of the leading end 234 is perpendicular to the helix C1 along which the first thread ridge 231 spirals.

The second thread ridge 232 has a leading portion 236 in the direction in which the second thread ridge 232 spirals, for example, the direction C2 in which a linear head 235 of the second thread ridge 232 extends. The leading portion 236 is tapered in width. In other words, a width of the leading portion 236 (or the dimension in the direction perpendicular to the direction C2 in which the linear head 235 extends) smoothly narrows toward a leading end 237 thereof.

The first thread groove 331 has a leading portion 334 in the direction in which the first thread groove 331 spirals, for example, the direction in which the center line C3 of a bottom 333 of the first thread groove 331 (i.e., a portion thereof at the maximum distance from the center axis of the internal thread 330) extends. The leading portion 334 is inversely tapered in width. In other words, a width of the leading portion 334 smoothly broadens toward a leading end 335 thereof.

The second thread groove 332 has transverse cross sections of constant shape and size thoroughly to its leading end 337 in the direction in which the second thread groove 332 spirals, for example, the direction C4 in which a linear bottom 336 of the second thread groove 332 extends. In particular, the surface of the leading end 337 is perpendicular to the helix C4 along which the second thread groove 332 spirals.

FIG. 5A shows the external thread 230 and the internal thread 330 when a relative rotation angle therebetween is close to an engagement start position. In an axial direction shared by the threads 230 and 330 (the left-right direction in FIG. 5A), the leading end 234 of the first thread ridge 231 is opposed to the leading portion 334 of the first thread groove 331, and the leading portion 236 of the second thread ridge 232 is opposed to the leading end 337 of the second thread groove 332. Accordingly, when the external thread 230 and the internal thread 330 get closer to each other, the leading end 234 of the first thread ridge 231 enters the leading portion 334 of the first thread groove 331, and the leading portion 236 of the second thread ridge 232 enters the second thread groove 332. (See dashed two dotted lines in FIG. 5A.)

The leading portion 334 of the first thread groove 331, because of being inversely tapered, has a width sufficiently broader than that of the leading end 234 of the first thread ridge 231. In addition, the leading portion 236 of the second thread ridge 232, because of being tapered, has a width sufficiently narrower than that of the leading end 337 of the second thread groove 332. Accordingly, the configuration in which the leading end 234 of the first thread ridge 231 is opposed to the leading portion 334 of the first thread groove 331 and the leading portion 236 of the second thread ridge 232 is opposed to the leading end 337 of the second thread groove 332, as shown in FIG. 5A, appears within a wider range of the relative rotation angle between the external thread 230 and the internal thread 330. As a result, during relative rotation of the threads 230 and 330, the leading end 234 of the first thread ridge 231 is likely to enter the leading portion 334 of the first thread groove 331 and the leading portion 236 of the second thread ridge 232 is likely to enter the second thread groove 332.

Since the leading portion 334 of the first thread groove 331 is inversely tapered, the leading end 234 of the first thread ridge 231, once coming in contact with the leading portion 334 of the first thread groove 331, is smoothly guided into a main body 338 thereof following the leading portion 334 (cf. a dotted region in FIG. Similarly, the leading portion 236 of the second thread ridge 232 is tapered, and accordingly, once the leading portion 236 comes in contact with the leading end 337 of the second thread groove 332, a main body 238 of the second thread ridge 232 following the leading portion 236 is smoothly guided into the leading end 337 of the second thread groove 332. This enables the external thread 230 and the internal thread 330 to easily start to be engaged with each other.

FIG. 5B shows the external thread 230 and the internal thread 330 when a relative rotation angle therebetween is far off the engagement start position. In the axial direction shared by the threads 230 and 330 (the left-right direction in FIG. the leading end 234 of the first thread ridge 231 is opposed to the leading end 337 of one of the second thread grooves 332, and the leading portions 236 of the second thread ridges 232 are opposed to either the leading portion 334 of the first thread groove 331 or the leading end 337 of another of the second thread grooves 332. Note that (i) the transverse cross sections of the first thread ridge 231 are of constant shape and size thoroughly to its leading end 234, (ii) the transverse cross sections of each of the second thread grooves 332 are of constant shape and size thoroughly to the leading end 337 thereof, and (iii) the transverse cross sections of the first thread ridge 231 extends beyond those of the second thread grooves 332 (cf. FIG. 4E). Accordingly, when the external thread 230 and the internal thread 330 get closer to each other while keeping their configuration shown in FIG. 5B, the leading end 234 of the first thread ridge 231 hits the leading end 337 of one of the second thread grooves 332 to be prevented from entering it. Thus, others of the second thread ridges 232 are also prevented from entering other thread grooves 331 and 332. This prevents the external thread 230 and the internal thread 330 from troubles such as friction welding.

[Modifications]

(1) In the tube fitting 100 according to the above-described embodiment of the invention, the fitting body 200 includes the annular groove 240, into which the annular protrusion 340 of the sleeve 300 is press-fitted. Conversely, the sleeve 300 may include an annular groove, into which an annular protrusion of the fitting body 200 may be press-fitted.

(2) Resin material of the tube fitting 100 according to the above-described embodiment of the invention is not limited to PA and PA-GE. Alternatively, various polymers such as low-density polyethylene, polypropylene, polycarbonate, polyacetal, polyether ether ketone, polyphenylene sulfide, and polyimide are available. These can be selected appropriately depending on fields where the tube fitting 100 is used, applications of the tube fitting 100, material of the hoses 510 and 520 or the like.

(3) In the tube fitting 100 according to the above-described embodiment of the invention, the thin-plate part 353 of the second engaging portion 352 bows in the axial direction of the sleeve 300 such that the engaging projection 356 enters the engaging hole 254 of the first engaging portion 252. However, structure of snap-fit engagement between the fitting body 200 and the sleeve 300 is not limited to combination of the first engaging portion 252 and the second engaging portion 352. Alternatively, a hook and a receiver may be provided to outer peripheries of the fitting body 200 and the sleeve 300, respectively or vice versa. The hook protrudes axially from a circumferential section of the outer periphery of the fitting body 200 or the sleeve 300, and it can bend radially outward. When the external thread 230 and the internal thread 330 reach an engagement finish position, the hook bends to engage its tip with the receiver. By visually identifying appearance of the hook engaged with the receiver and aurally identifying sound of the hook hitting the receiver, a worker can easily confirm if the external thread 230 and the internal thread 330 reach the engagement finish position.

(4) In the tube fitting 100 according to the above-described embodiment of the invention, both the external thread 230 of the fitting body 200 and the internal thread 330 of the sleeve 300 are double start threads. However, as shown in FIGS. 5A and 5B, they may have three or more thread ridges. In this case, the external thread 230 may include one or more thread ridges with transverse cross sections of different shape or size in addition to the first thread ridge 231 and the second thread ridge 232.

(5) In the tube fitting 100 according to the above-described embodiment of the invention, the number of the first thread ridge 231 is one, but it may be two or more. In this case, the number of engagement start positions of the external and internal threads may be designed to be two or more. For example, when two each of the first and second thread ridges are arranged alternately in the circumferential direction of the external thread, there exists two engagement start positions.

(6) In the tube fitting 100 according to the above-described embodiment of the invention, transverse cross sections of the first thread ridge 231 are of a trapezoidal shape, and those of the second thread ridge 232 are of a triangular shape. However, shapes of the transverse cross sections are not limited to them, but they may be polygons such as rectangles and saw tooth or shapes with round tops like round threads.

(7) In the tube fitting 100 according to the above-described embodiment of the invention, the first thread ridge 231 and the second thread groove 332 have transverse cross sections of a constant shape and size thoroughly to their leading ends 234 and 337, respectively. However, these structures are not essential. If a first thread ridge and a second thread groove meet the condition “transverse cross sections of the leading portion of the first thread ridge have a shape extending beyond transverse cross sections of the leading portion of the second thread groove,” the leading end of the first thread ridge can be designed to hit the leading end of the second thread groove to be prevented from entering the second thread groove. Accordingly, as long as the above-mentioned condition is met, the leading portion of the first thread ridge may be formed in a shape easy to enter the leading portion of the first thread groove or the leading portion of the second thread groove may be formed in a shape easy to allow the leading portion of the second thread ridge to enter the leading portion of the second thread groove.

In the example shown in FIG. 4E, for example, the leading end 234 of the first thread ridge 231 may be provided with a rounded or beveled corner or the leading end 337 of the second thread groove 332 may be provided with a rounded or beveled rim as long as the head 233 of the first thread ridge 231 changelessly extends beyond the second thread groove 332 in the width direction. Alternatively, if the height of the first thread ridge (i.e., its dimension in radial direction of the external thread) is larger than the depth of the second thread groove (i.e., its dimension in radial direction of the internal thread), the leading portion of the first thread ridge may be tapered in width while being constant in height or the leading portion of the second thread groove may be inversely tapered in width while being constant in depth.

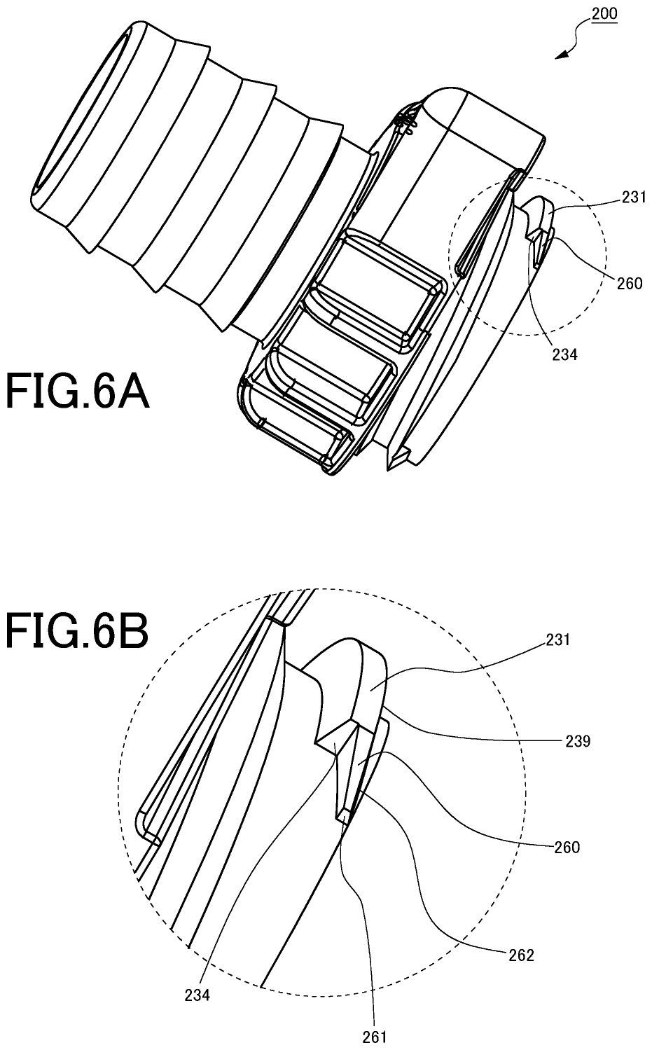

(8) FIG. 6A is a perspective view showing an appearance of a modification of the tube fitting 200, and FIG. 6B is an enlarged view of a region surrounded by a broken line in FIG. 6A. As shown in FIGS. 6A and 6B, a projecting portion 260 may protrude along an elongated direction of a helix along which the first thread ridge 231 spirals (e.g., the direction of the center line C1 of the head 233 shown in FIG. 5A). As shown in FIG. 6B, the projecting portion 260 smoothly reduces both its width and height (i.e., its dimension in radial direction of the fitting body 200) toward the leading end 261 thereof. A side surface 262 of the projecting portion 260 located on a side close to the leading end of the external thread 230 (on its right side in FIG. 6B) is continuously connected with a flank 239 of the first thread ridge 231 located on the same side. Transverse cross sections of the projecting portion 260 are sufficiently smaller than those of the first thread ridge 231, and in particular, designed to be fit into those of the second thread groove 332. As a result, at the boundary between the projecting portion 260 and the leading end 234 of the first thread ridge 231, their widths change stepwise.

When the external thread 230 and the internal thread 330 are arranged such that the leading end 234 of the first thread ridge 231 is opposed to the leading end 337 of the second thread groove 332 as shown in FIG. 5B, the projecting portion 260 can enter the second thread groove 332. In this case, the leading end 234 of the first thread ridge 231 subsequently hits the leading end 337 of the second thread groove 332. The projecting portion 260 entering and hitting the second thread groove 332 is sensed by a worker as haptic responses, and thus, the tube fitting 100 can remind the worker that the external thread 230 and the internal thread 330 are arranged in a position shown in FIG. 5B. Since the arrangement can be a clue, the worker can easily find the engagement start position.

What is claimed is:

1. A tube fitting comprising:
a fitting body having a tubular shape whose first axial end portion includes an external thread and whose second axial end portion is to be connected with a first tube; and
a sleeve whose first axial end portion is to be connected with a second tube and whose second axial end portion includes an internal thread to be engaged with the external thread, wherein:
one of the external and internal threads includes first and second thread ridges whose transverse cross sections different in shape or size;
the other of the external and internal threads includes a first thread groove whose transverse cross section allows the transverse cross section of the first thread ridge to be fit thereinto, and
a second thread groove whose transverse cross section prevents the transverse cross section of the first thread ridge from being fit thereinto but allows the transverse cross section of the second thread ridge to be fit thereinto;
the first and second thread ridges and the first and second thread grooves have leading portions in their respective directions in which they spiral;
the leading portion of the second thread ridge is tapered in width;
the leading portion of the first thread groove is inversely tapered in width; and
the leading portion of the first thread ridge has a transverse cross section that extends beyond a transverse cross section of the leading portion of the second thread groove.

2. The tube fitting according to claim 1 wherein:
a leading end of the first thread ridge includes a projecting portion that protrudes along an elongated direction of a helix along which the first thread ridge spirals; and
the projecting portion has a transverse cross section that is fit into the transverse cross section of the second thread groove.

3. The tube fitting according to claim 1 wherein:
a circumferential section of an outer periphery of the fitting body includes a first engaging portion;
a circumferential section of an outer periphery of the sleeve includes a second engaging portion; and
the first engaging portion is snap-fitted with the second engaging portion when the internal thread reaches an engagement finish position relative to the external thread.
